(19) United States
(12) Patent Application Publication
(10) Pub. No.: US 2007/0137328 A1
(43) Pub. Date: Jun. 21, 2007

(54) Force generator machine: which utilizes a rotational imbalance through the use of hydraulic fluid motive mass

(76) Inventor: Michael J. Gillespie III, Dunellen, NJ (US)

Correspondence Address: MICHAEL GILLESPIE, 320 PARK PLACE, DUNELLEN, NJ, 08812, US

(21) Appl. No.: 11/268,084

(22) Filed: Nov. 7, 2005

(51) Int. Cl. F16H 27/04

(52) U.S. Cl. 74/84 S

(57) ABSTRACT

The patent describes a method for generating a net linear force with a rotational machine forced into imbalance utilizing a fluid mass. The fluid mass is added to, and rejected from the rotor to load one half of the rotation with more mass than the other half, thereby causing a net reaction force in the direction of the loaded half of the rotation. This patent is intended specifically to cover the method of utilizing a Fluid Motive Mass for a rotational imbalance in a force generating machine.

### CROSS-REFERENCE TO RELATED APPLICATIONS

None, besides reference to future submittal of Rotor Design Patent.

### BACKGROUND OF THE INVENTION

The objective of the invention is to create a machine that provides a force generated in one linear direction, without interaction with the surrounding environment. The method of force delivery had to be stable, even, and useable in several different applications. The resultant force of the machine would be used to generate acceleration of the machine and any attached components in any linear direction. This means that the same machine would be able to compensate for the acceleration of gravity, and could produce motion linearly, allowing travel in any direction.

The initial investigation into utilization of fixed mass weights, which would be extended and contracted within a rotating machine proved complicated, unsteady, and limited in the speed of the rotor. Also, upon investigation into the US Patent library, this method of energy delivery has previously been investigated, and patented in several cases. It became apparent that the loading of one half of the rotation would have to be accomplished by using a mass of fluid. This mass would be added to a cup, bucket, void space, or other cylinder, which would accelerate the fluid to the rotational speed without slowing the rotor to any great extent, hold the fluid through half of the arc, and then release the fluid to unload that area of mass for the remaining half of the rotation. This fluid throughout this report will be referred to as the Fluid Motive Mass, as this is creating the reactionary forces on the machine. The bucket or void space that would receive the mass will be referred to as the Fluid Motive Mass Reservoir.

Combining this theorem with a working knowledge of fundamental physics and standard mechanical engineering practices yields a rotational machine that is capable of producing a significant amount of force, at a relatively stable and steady magnitude.

### BRIEF SUMMARY OF INVENTION

This application for utility patent is for the concept of utilizing a Fluid Motive Mass to cause a rotational imbalance within a rotational machine that subsequently produces a force in one linear direction. Specific design patents will be submitted by the Inventor for the design of the rotor that would accomplish this process.

The machine would consist of two counter-spinning rotors within the same rotational plane. Each rotor would have a number of Fluid Motive Mass Reservoirs (FMMR), at evenly spaced intervals. The machine would add Fluid Motive Mass to the FMMR at the beginning of a rotation cycle and reject the motive fluid mass at mid point of the rotation (0 degrees and 180 degrees). The timing for the addition of mass would be offset by the number of degrees that each FMMR is offset from the “Base” FMMR, which will effectively force each FMMR to add and subtract mass at the same location when looking at the rotor from the system view.

The weighted half of the rotation would generate a centripetal force that would exceed the centripetal force of the un-weighted half, effectively generating a rotational imbalance and a resultant linear force in a singular direction. There would be more than two FMMR's in the rotor in order to even out the magnitude of the force in this direction, and to overcome the losses of accelerating and decelerating the mass to and from the rotational speed of the FMMR.

In this fashion, a small amount of Motive Fluid Mass per rotating void space, at a high angular velocity of the rotor, will produce a significant amount of net force in one direction, at an apparent steady rate. The force pulsations can be equated to an alternating current voltage graph, except that the forces are additive in nature, such that the resultant output force is always well above zero, and is at a high enough frequency to function as a steady force. For example, a rotor spinning at 4000 rpm, with 4 void spaces will have a force pulsation of 16,000 hz, which will most likely be emitted as sound, and will not be actually impact the steady nature of the machine.

### DETAILED DESCRIPTION OF INVENTION

Note that this description is for the concept of utilizing a Fluid Motive Mass to cause a rotational imbalance within a rotational machine that subsequently produces a force in one linear direction. Specific design patents will be submitted by the Inventor for the design of the rotor that would accomplish this process.

There are several fundamental equations in which this system operates:
Force Equation:Force=Mass*Acceleration
Centripetal Force Equation:Force=Mass*(Velocity²)/Radius
Law of Energy Conservation:Energy In=Energy Out

Definitions:
Fluid Motive Mass (FMM): This is the fluid mass which is added to the rotor in order to “load” one half of the rotation, and cause the rotational imbalance.
Fluid Motive Mass Reservoir (FMMR): This is the cylinder, bucket, or other appurtenance which is incorporated into the rotor assembly which receives and discharges FMM at specific intervals within the Force Generator Machine assembly.
Rotor: This is the assembly of 3 or more FMMR's, and all mechanical parts that allow the FMMR's to operate, including, but not limited to shafting, fluid ports, bearing assemblies, valves, etc.
Force Generator Machine (FGM): This is the assembly of two, or multiple of two, counter-rotating rotor assemblies, which are synchronized with respect to the FMMR's.
Load (weighted): To add FMM to the rotor assembly for a given interval. (A loaded portion of the rotor)
Unload (unweighted): To subtract FMM from the rotor assembly for a given interval. (An unloaded portion of the rotor)

The objective of the machine is to create a rotational imbalance in a singular direction that translates into a linear net force in a singular direction. This can be done by “loading” one half of a rotating body with added mass for the first half of the rotation, and “unloading” the same mass for the second half of the rotation. The resultant force of the entire system, due to the centripetal force required between the mass and the center of the rotating body, cumulative through the full rotation of the rotor, yields a reaction force in one net direction. This direction will be labeled “Y”. In order to eliminate forces that may be generated in the perpendicular direction due to partial imbalances, direction “X”, two rotors are placed co-planer, and synchronized such that the forces in this X direction are cancelled out. The centripetal force imbalance, combined with the cancellation of perpendicular forces, will cause a net force to be generated in a singular direction. This force will subsequently cause an acceleration of the machine in the direction of the net force of the rotors, which evens out the Law of Energy Conservation.

Attached as Exhibit A of this Patent is a spreadsheet print out of data, which analyzes on possible orientation of a possible rotor assembly. The rotor modeled in the spreadsheet has 4 FMMR's and utilizes 0.21 bm of FMM per FMMR per revolution. The first sheet of the print is a set of master control parameters, including total FMM, the RPM of the rotor, and a loading and unloading profile of the FMM. The second through seventh sheets are output data from one FMMR. The last sheet illustrates each FMMR Y direction forces, and a “One Rotor” graph of the added forces from each FMMR in the illustrated rotor. As shown on the graph, there are areas where the rotors that are loading and unloading impact the overall force generated, but the force is not sufficient to negate the force generated by another rotor in it's full swing upwards.

The Rotor and the FMM:

The rotor consists of a disc, or rotating arms, which include void spaces which are able to receive and discharge fluid of a given mass. The fluid used is known as the Fluid Motive Mass or FMM. The mechanical system of conveyance of the FMM is determined based on the actual design of the rotor, which is to be patented under a Design Patent. Each Fluid Motive Mass Receiver (FMMR) is located at a point offset from the rotational centerline of the rotor.

Overall, the FMMR can be modeled mathematically by taking the net forces in both the X and Y directions, in order to analyze the instantaneous forces exerted within the system. There are two major forces that act on the FMMR: The acceleration and deceleration forces of the FMM and the centripetal force exerted to retain the FMM within the FMMR.

The acceleration and deceleration forces take into account the requirement to accelerate the added FMM to the operating speed of the rotor within the FMMR. It also takes into account the deceleration of the same FMM when it is rejected from the FMMR, where it will inevitably collide with the FMM collection system within the machine, which will return the FMM to the FMMR at the specified time. The acceleration and deceleration forces fall into the equation F=M*A, where the force generated is tangential to the rotation. By using simple geometric formulas, this force is broken into X and Y components based on the rotational position of the FMMR.

The centripetal force is simply calculated by utilizing the F=M*V²/R. The Mass through the loaded half of the rotation is greater than the unloaded half. The forces generated are greater in this half of the rotation, and when all forces around the rotation are broken into components of X and Y, and totalized, the net force for Y is positive.

For the entire rotation, the cumulative forces of acceleration and centripetal force are shown to be in a net positive Y direction. There are portions when the mass is accelerated and decelerated where the instantaneous force is negative, but the multiple FMMR areas on the rotor alleviate this problem by compensating for the negative Y force, with a centripetal positive Y force.

Each rotor must contain other FMMR's offset in order to compensate for the accelerating and decelerating forces by utilizing the Y component of the loaded rotating mass. By utilizing a larger, positive Y component force, the acceleration/deceleration forces will be compensated or exceeded, and the resultant will be a net positive force throughout the rotation of the rotor.

Tendency for Rotational Velocity to Change Due to Energy Consumption:

The premise of this rotor is that the velocity will be held constant, or relatively constant. Energy is being expended by both accelerating the mass, and the requirement to maintain a rotation of an imbalanced force, there will be a prime mover required to drive the rotor. The acceleration power required is simply calculated, per rotation, as force multiplied by the time. The centripetal acceleration power is calculated by the use of the integral of the force, multiplied by the time, around the entire rotation of the rotor.

There will be a tendency, as mass is added and subtracted, for the rotor to increase and decrease in speed. The relative stability in rotational velocity will be accomplished through the rigid connection of each FMMR supporting structure, which will act as rotational inertia, much the same way a flywheel functions within an internal combustion engine.

Energy will be added and subtracted from the entire rotating body by the force generation process, but the prime mover must overcome this energy loss by input to the center shaft. Other design patents will cover specific design of the rotor and prime mover assemblies.

Relative Stability and Smooth Force Delivery:

The rotor, as stated above, will contain 3 or more FMMR's. Each FMMR will generate a force curve, as illustrated by the attached chart. The net force as illustrated, is always above zero, when the rotor is totalized. There exist pulses of force, which are the result of the centripetal forces, in a single direction, but these pulses are at such a high frequency, the resultant output seems constant. For example, if the attached chart's timescale is increased to include 1 minute worth of data, at 4000 revolutions per minute, with 4 FMMR's, the resultant total force chart would appear to be more or less a straight line. This perceived constant force is only subject to sound generation at the frequency relative to generator speed. It is unknown at this time what the magnitude of the sound generated would truly be, but is inconsequential to the patent methodology.

### BRIEF DESCRIPTION OF THE DRAWINGS

Drawing 1/11—Definition of Coordinate System and Relative Terms

FIG. 1A: This is a profile view, or front view of a rotor example. It shows several FMMR's, the direction of rotation, center of rotation, arc of FMMR rotation, and defines the X and Y axes for purposes of discussion.

Fig. 1B: This figure is a top view, illustrating the depth of the rotor.

Fig. 1C: This figure is a side view, illustrating the depth of the rotor. It can also be seen that the top and side views are the same, which illustrates the symmetry of the rotor body.

Drawing 1 Notes: The notes are self-explanatory.

Drawing 2/11—Definition of Rotor Loading Regions

FIG. 2: This figure shows the four regions of interest of the FMMR through one cycle of the rotor in order for the reviewer to understand the cycle. This is illustrated to show how the system works. Each force component (acceleration/deceleration and centripetal forces) are broken down on subsequent drawings.

Drawing 2 Notes: The notes are self-explanatory.

Drawing 3/11—Centripetal Force Analysis

FIG. 3A: This figure illustrates the regions of centripetal force generation. The Loaded Region, or top half of this example, shows loaded FMMR's, which cause reaction forces as illustrated in FIG. 3B. The Unloaded Region shows unloaded FMMR's, which contribute no centripetal force caused by FMM.

FIG. 3B: This figure illustrates the forces exerted by the FMMR in the loaded region (as illustrated in FIG. 3A). The figure shows the centripetal force broken down into the X and Y directions. It can be seen that the net force through the loaded arc would be in the Y direction, due to the fact that the X-direction forces in one portion could be cancelled out by the other portion.

Drawing 3 notes: The notes are self-explanatory. Governing equations are listed for illustration purposes

Drawing 4/11—Acceleration Force Analysis

FIG. 4A: FIG. 4A on Drawing 4/11 illustrates two possible regions in which mass is added to (loaded), and subtracted (unloaded) from the FMMR. The FMMR Loading Region is illustrated further in FIG. 4B. The FMMR Unloading Region is illustrated further in FIG. 4C.

FIG. 4B: This figure illustrates the Acceleration reaction forces that the body will exhibit due to the change in velocity of the FMM from zero to the tangential velocity of the FMMR. The Net Reaction force in this region in this figure, is in the Negative Y direction.

FIG. 4C: This figure illustrates the Acceleration reaction forces that the body will exhibit due to the change in velocity of the FMM from the tangential velocity of the FMMR, to zero when the mass is expelled from the FMMR. The Net Reaction force in this region in this figure, is in the Negative Y direction.

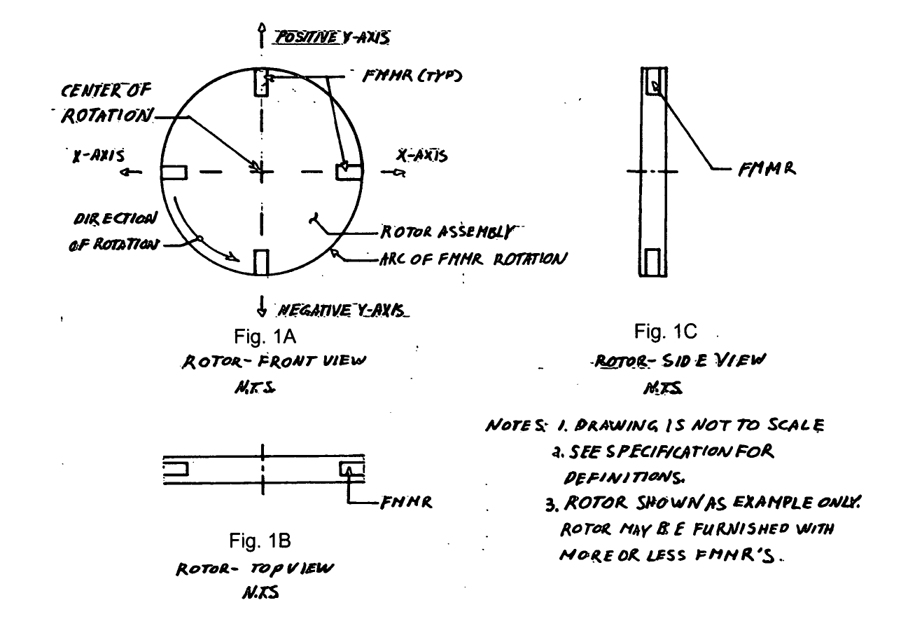

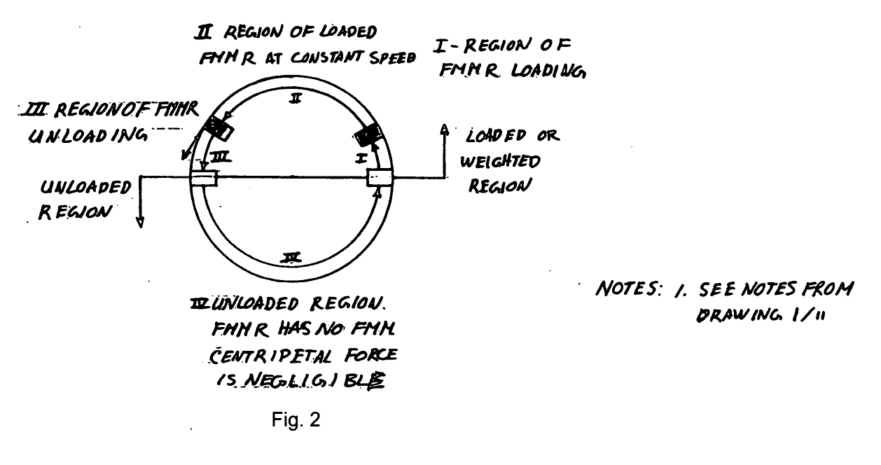

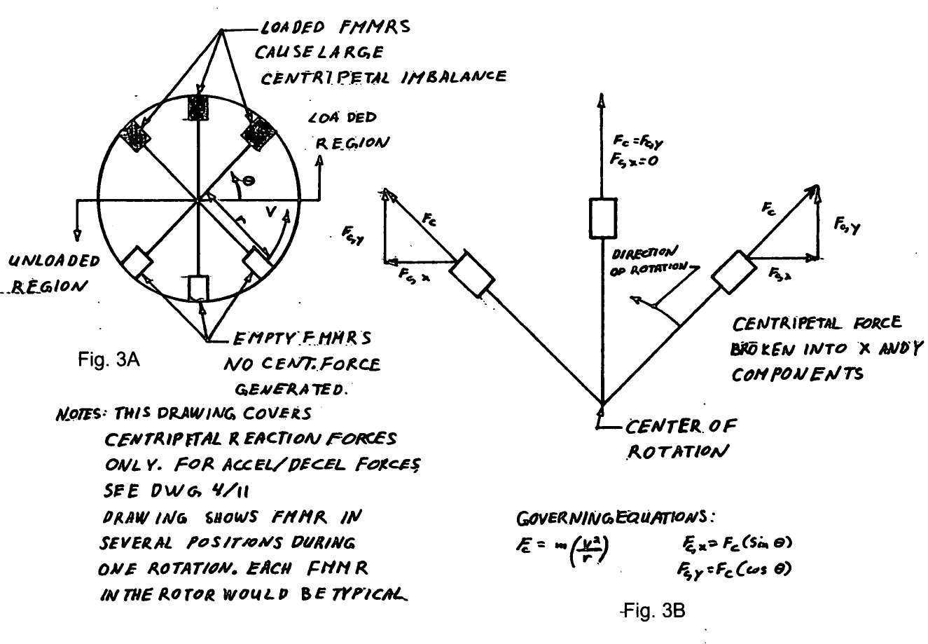

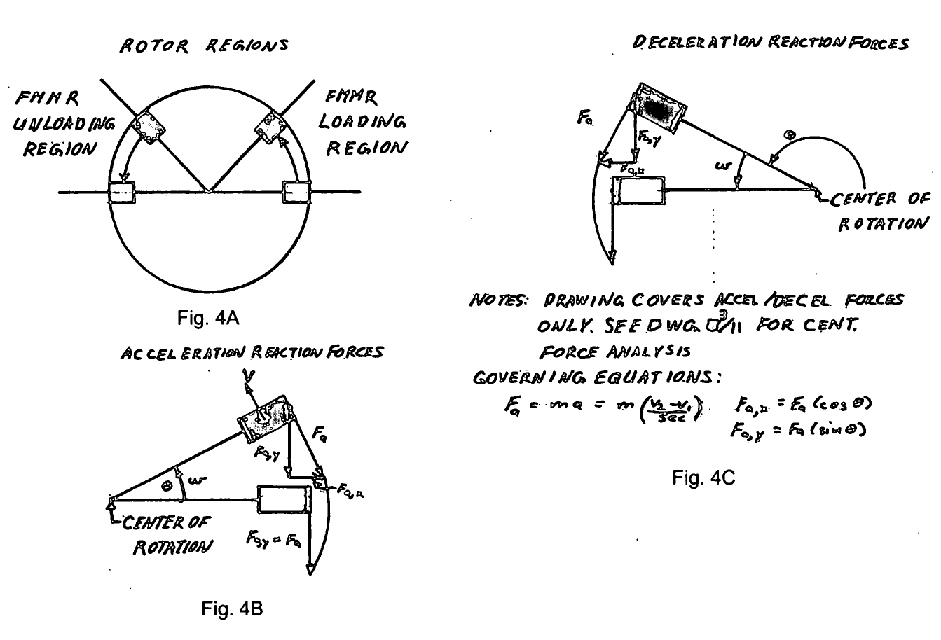

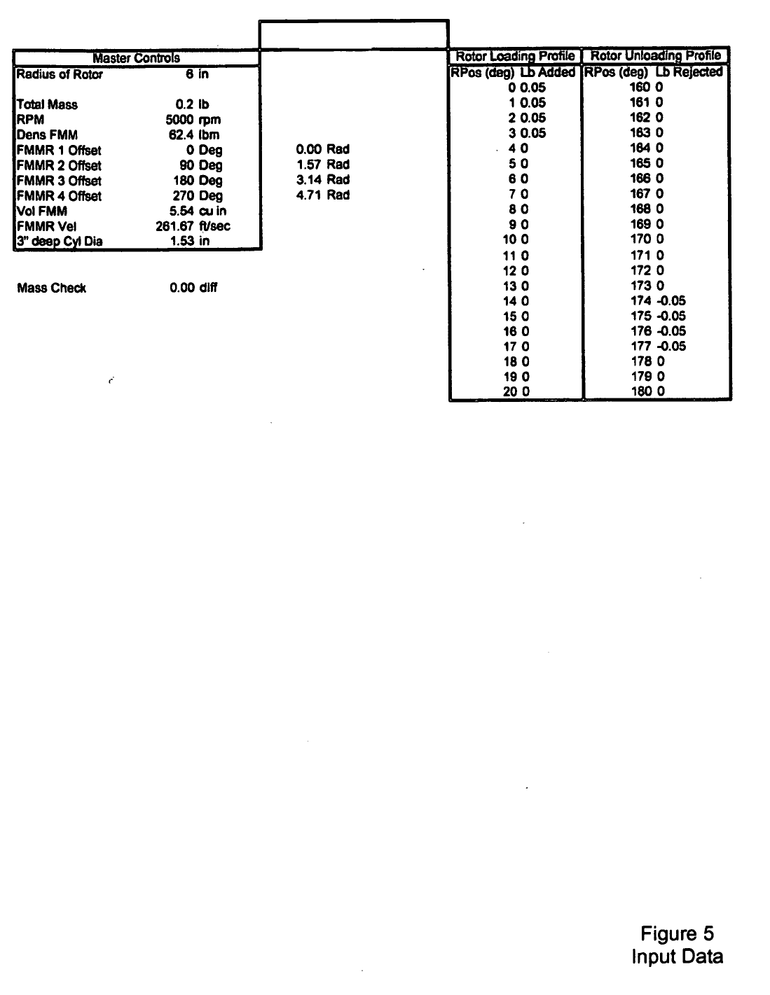

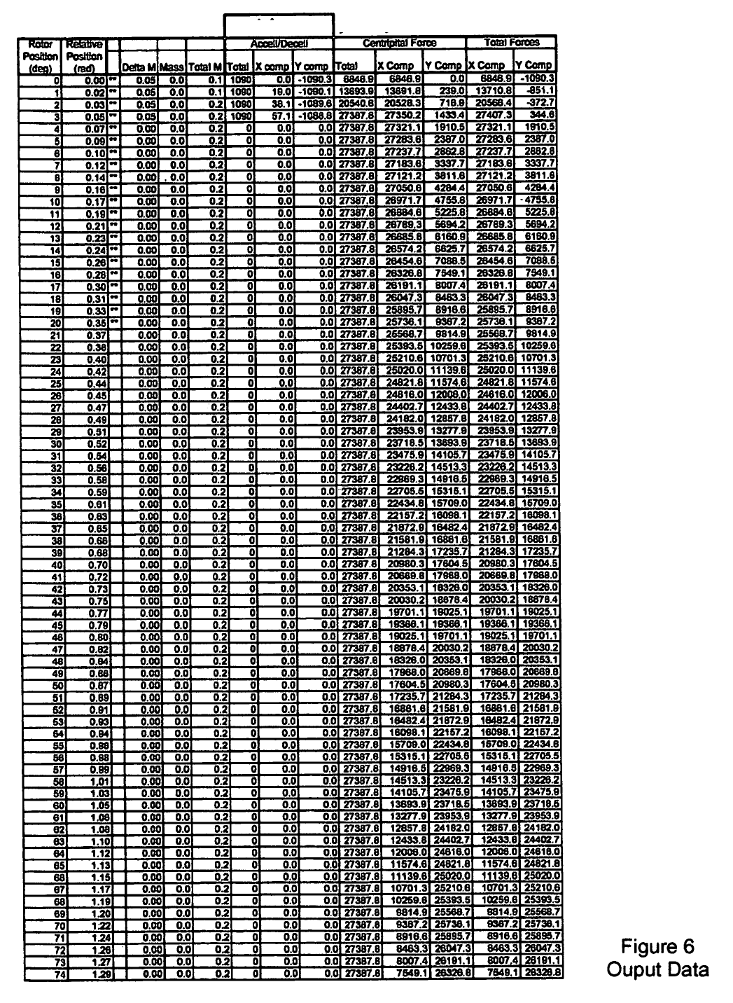

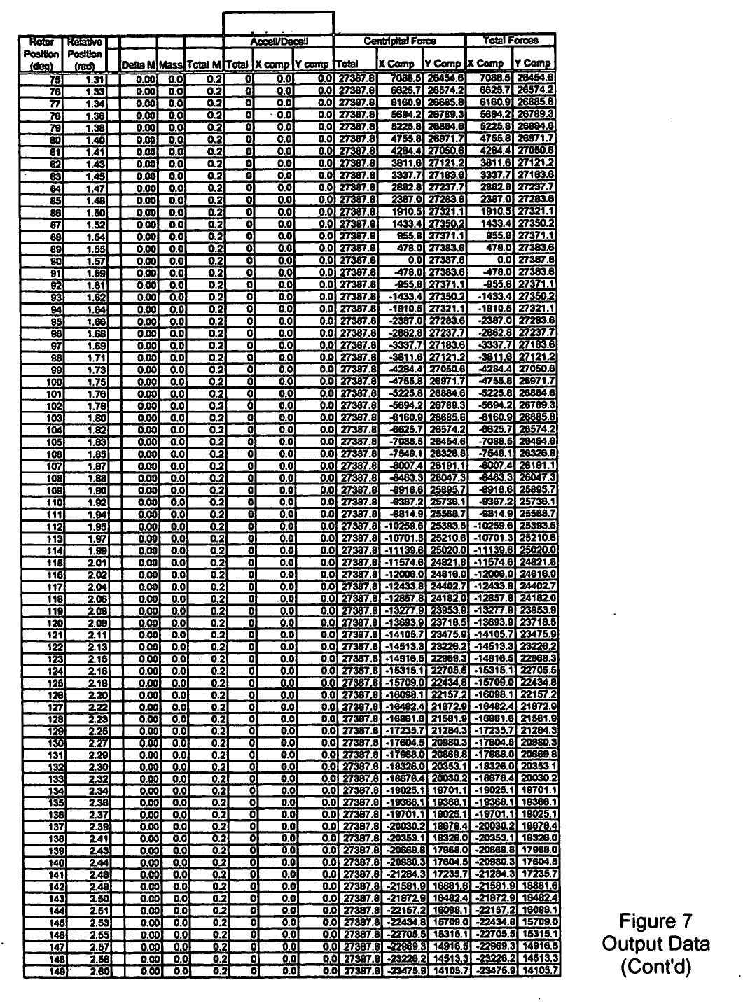

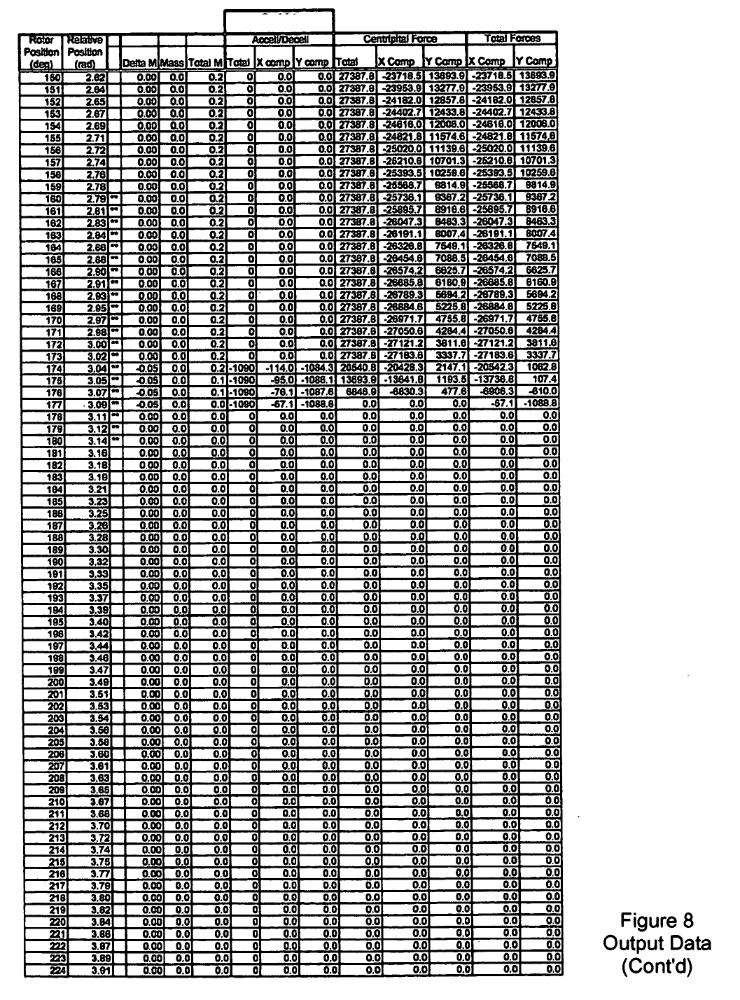

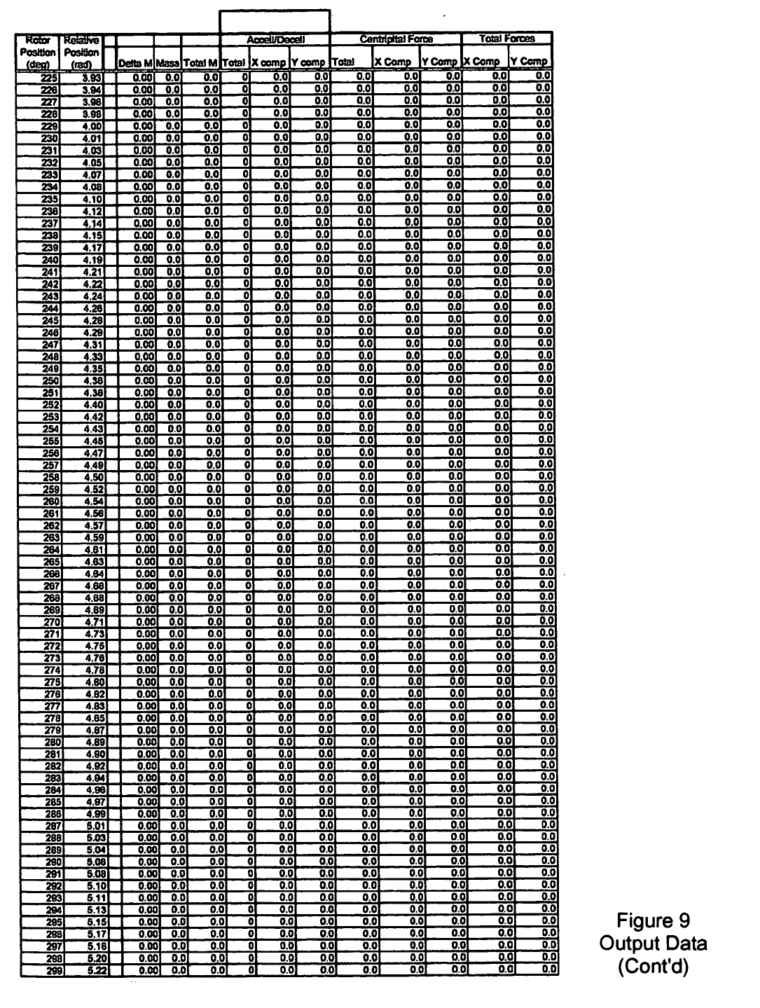

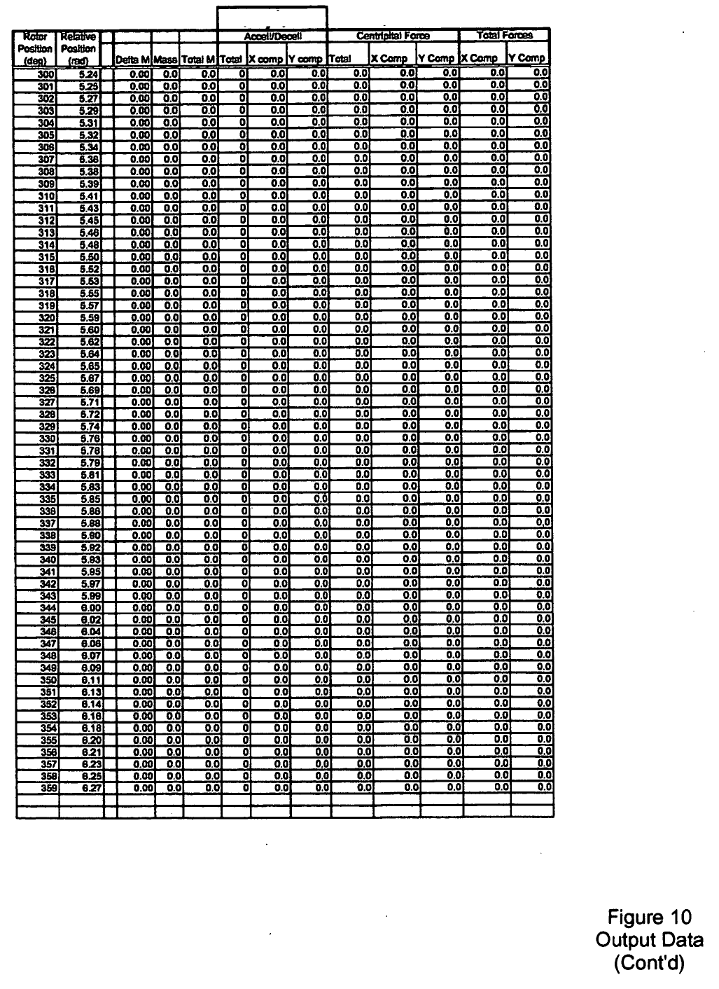

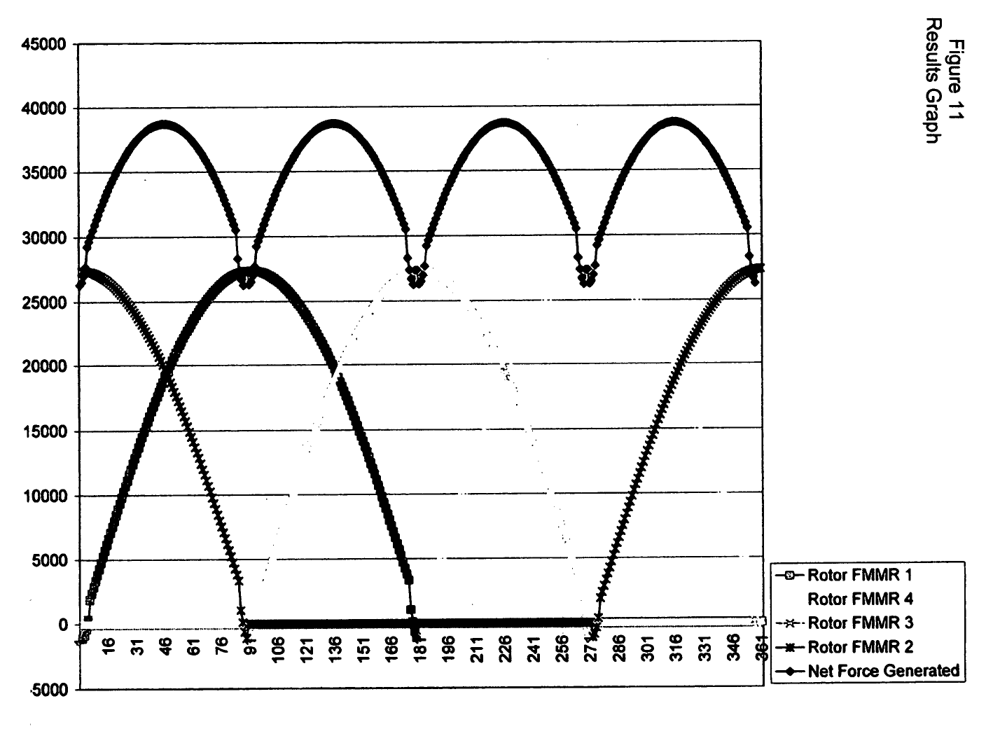

Drawing 4 Notes: Notes are self-explanatory. Governing equations are listed for illustration purposes.

Drawing 5/11—Example Rotor Excel Worksheet: This drawing is the input sheet from an Microsoft Excel spreadsheet showing the input parameters used for the example analysis on the subsequent drawings.

Drawing 6/11 through 10/11—Rotor Cycle Data: These drawings show the calculated data for each degree of motion for one FMMR, showing the instantaneous forces at that specific location of the FMMR for the input data on drawing 5/11.

Drawing 11/11—Rotor Data Graph: This is a graph showing four FMMR's which would have typical data to that shown in drawings 6/11 through 10/11, but would be offset a number of degrees in the cycle. In this case, with four FMMR's, each FMMR is set 90 degrees apart.

1. A method of generating a rotational imbalance that yields a force in one linear direction.

2. The method according to claim 1 utilizes two counter-rotating rotors in order to cancel out forces perpendicular to the weighted centripetal net force.

3. That the rotors in claim 2 utilize reservoirs for fluid motive mass.

4. That the reservoirs in claim 3 may receive and reject mass with a specific timing.

5. That the rotors in claim 2 utilize more than 2 fluid motive mass reservoirs in order to compensate for acceleration forces of the fluid motive mass.

6. That the timing in claim 4 for adding and subtracting fluid motive mass causes a loaded and unloaded portion of a rotation.

7. That the timing in claim 5 causes a rotational imbalance, which causes a net linear force in one direction.

8. That the rotor assembly in claim 1 will require a prime mover to maintain rotational velocity.
